(19) United States
(12) Patent Application Publication
(10) Pub. No.: US 2006/0033948 A1
(43) Pub. Date: Feb. 16, 2006

(54) Image forming apparatus

(75) Inventor: Norihiro Yamamoto, Numazu-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/917,803

(22) Filed: Aug. 12, 2004

(51) Int. Cl. G06F 3/12

(52) U.S. Cl. 358/1.15

(57) ABSTRACT

An image forming apparatus includes various interfaces which receive job data, a communication control module which creates job data of a given file format based on the job data of different formats received by the interfaces, an entry unit which enters a job in a table based on the job data of the given file format created by the communication control module, and an application job control unit which executes the job entered in the table of the entry unit.

### BACKGROUND OF THE INVENTION

1. Field of the Invention

The present invention relates to an image forming apparatus having a module that performs communication with an external device via an interface and processes data received through the communication.

2. Description of the Related Art

An image forming apparatus includes various interfaces for connecting the apparatus to an external device. A module is provided for each of the interfaces to perform communication control to receive data from the external device and process the received data. When an interface is expanded, its corresponding module has to be extensively modified. When an interface is added, its corresponding module has to be newly provided.

As described above, the modules and interfaces are in a one-to-one correspondence. When an interface is newly added or expanded, its corresponding module has to be provided even though there has already been a module having the same function as that of the module corresponding to the interface.

Accordingly, there is a need for an image forming apparatus capable of adapting to various interfaces by a single module and adding and expanding an interface with a minimum of effort.

### BRIEF SUMMARY OF THE INVENTION

According to an aspect of the present invention, there is provided an image forming apparatus comprising various interfaces which receive job data, a communication control module which creates job data of a given file format based on the job data of different formats received by the interfaces, an entry unit which enters a job in a table based on the job data of the given file format created by the communication control module, and an application job control unit which executes the job entered in the table of the entry unit.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description of given below, serve to explain the principles of the invention.

FIG. 1 is a schematic diagram of the internal structure of an MFP according to an embodiment of the present invention.

FIG. 2 is a diagram illustrating various interfaces in more detail.

FIG. 3 is a flowchart showing a process to be performed by a CPU upon receiving job data.

FIG. 4 is an illustration of the structure of job data.

### DETAILED DESCRIPTION OF THE INVENTION

An embodiment of the present invention will now be described with reference to the accompanying drawings.

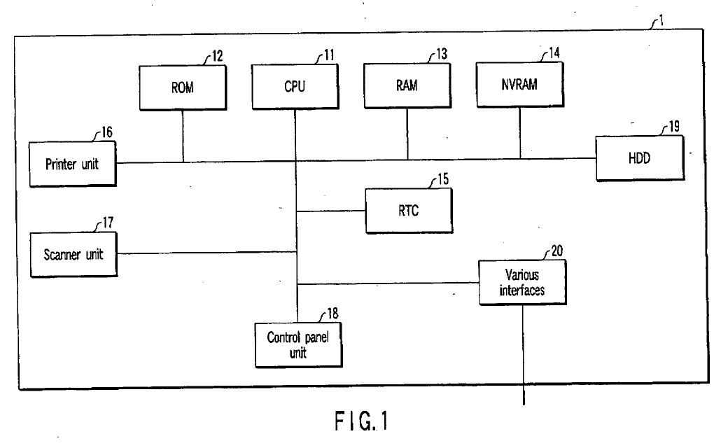

FIG. 1 schematically shows the internal structure of multifunction peripherals (MFP) 1 as an image forming apparatus having a copying function, a network printing function and a network scanning function. As shown in FIG. 1, the MFP 1 includes a CPU 11, a ROM 12, a RAM 13, an NVRAM 14, an RTC 15, a printer unit 16, a scanner unit 17, a control panel unit 18, a hard disk drive (HDD) 19 and various interfaces 20. The CPU 11 is connected to the ROM 12, RAM 13, NVRAM 14, real time clock (RTC) 15, printer unit 16, scanner unit 17, control panel unit 18, HDD 19 and interfaces 20 through bus lines.

The CPU 11 achieves an operation of the MFP 1 by performing a process to exercise control over the respective components based on the control programs stored in the ROM 12. The ROM 12 is a rewritable memory for storing, e.g., control programs that the CPU 11 executes. The RAM 13 has, e.g., a work area necessary for executing the control programs stored in the ROM 12 by the CPU 11. The NVRAM 14 is a nonvolatile memory for storing various items of data such as maintenance information and the number of prints with backup of a power supply (not shown).

The RTC 15 generates the current time information. When the CPU 11 performs various processes, their related information is recorded in the NVRAM 14 in association with the current time information generated by the RTC 15.

Upon receiving image data, the printer unit 16 forms an image based on the image data. The structure and operation of the printer unit 16 for forming an image based on the image data are conventional and thus their descriptions are omitted.

The scanner unit 17 scans documents placed on a document table (not shown) and a plurality of documents fed in sequence from an automatic document feeder (ADF) to read an image and generate image data. The structure and operation of the scanner unit 17 for reading image data are also conventional and thus their descriptions are omitted.

The control panel unit 18 includes an operating section for inputting various instructions to the CPU 11 by a user and a display section for displaying various items of information to be given to the user under the control of the CPU 11.

The HDD 19 is divided into a plurality of areas by partitions to store image data in accordance with the types of jobs received through the interfaces 20. The HDD 19 spools image data, which is contained in job data received through the interfaces 20, on a data folder created in accordance with the jobs under the control of the CPU 11.

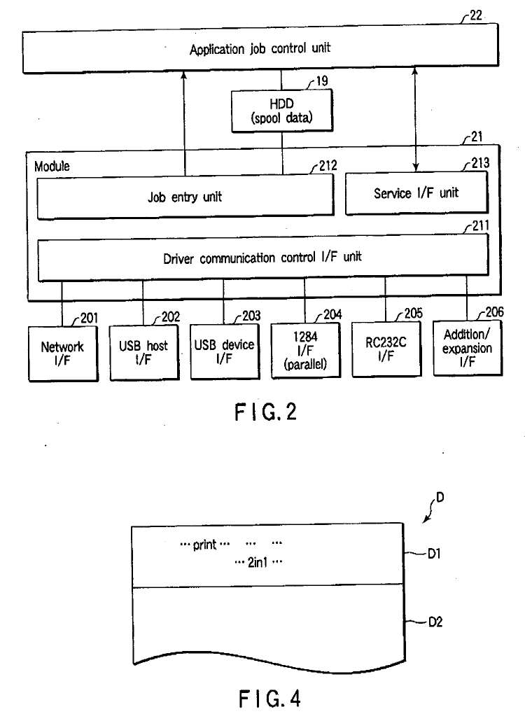

Various interfaces 20 will be described with reference to FIG. 2. As shown in FIG. 2, a module 21 is communicably connected to an application job control unit 22, the HDD 19, a network interface (I/F) 201, a USB host interface (I/F) 202, a USB device interface (I/F) 203, a 1284 (parallel) interface (I/F) 204, an RC 232 interface (I/F) 205 and an addition/expansion interface (I/F) 206.

Each of the interfaces (I/F) 201 to 206 is configured by hardware. The interfaces (I/F) 201 to 205 communicate with an external device connected thereto via a cable (not shown) to receive job data of different formats in accordance with interfaces of a print job, a job about facsimile, a job about the output of maintenance information and the like. The addition/expansion interface (I/F) 206 is used to add an interface that is not provided in an MFP 1, such as a radio communication interface such as Bluetooth and an interface of another standard.

The module 21 is configured by software and stored in the ROM 12 described above. The module 21 has a hierarchical structure of two layers of a driver communication control I/F unit 211 and each of a job entry unit 212 and a service I/F unit 213. The job entry unit 212 and service I/F unit 213 compose an entry unit. The driver communication control I/F unit 211, job entry unit 212 and service I/F unit 213 are independent of one another.

The driver communication control I/F unit 211 is a module for communication control to transmit/receive data to/from an external device using each of the interfaces 201 to 205. The driver communication control I/F unit 211 is a program that is created to correspond to all of the interfaces 201 to 205 based on the program for communication control using the network interface 201, which is the most complicated one of programs for controlling communications with the interfaces 201 to 206. As shown in the figure, the driver communication control I/F unit 211 controls communication with each of the interfaces 201 to 205 that are provided in the MFP 1, and captures job data from each of the interfaces 201 to 205. The driver communication control I/F unit 211 creates a job of a given file format based on the job data received by each of the interfaces 201 to 205, irrespective of the format of the job data.

The job entry unit 212 writes and stores data in the HDD 19 based on the job created by the driver communication control I/F unit 211 and enters a job in the table of the application job control unit 22.

The service I/F unit 213 enters a job in the table of the application job control unit 22 based on the job created by the driver communication control I/F unit 211.

Even though some of the interfaces 201 to 205 transmit job data, the driver communication control I/F unit 211, job entry unit 212 and service I/F unit 213 can perform a data flow sequential operation in the order in which they have received job data from the interfaces in order to shorten the time for supplying data to the application job control unit 22.

The application job control unit 22 has a table unique to each of application software programs for fulfilling various functions. If a job is entered in the unique table, the application job control unit 22 starts up application software corresponding to the entered job and executes the job.

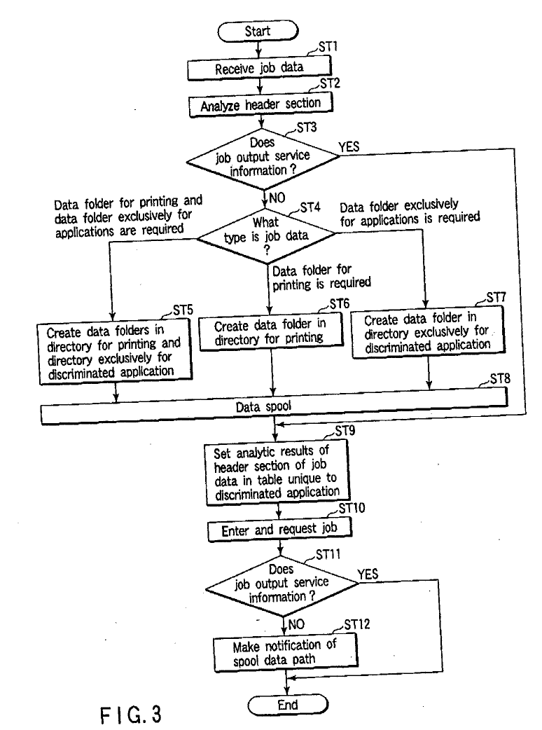

A process to be performed by the CPU 11 upon receiving job data will be described in more detail with reference to the flowchart shown in FIG. 3.

The CPU 11 recognizes that it receives job data from any one of external devices connected to the interfaces 201 to 205 (step ST1). This job data has a data structure as shown in FIG. 4. The job data D includes a header section D1 and a data section D2. The header section D1 is written with information indicating which of application software programs such as “printing,” “scanning,” “output of maintenance information” and “updating of firmware” is executed (or indicating the type of an application) and information indicating the format for executing the application software programs. If the contents of a job represent “2-in-1 printing” as shown in FIG. 4, “2-in-1” and “printing” are described in the header section D1, and image data of each page is added to the header section D1 as the data section D2.

The CPU 11 analyzes the header section D1 of the received job data D. In other words, the CPU 11 analyzes information indicative of the type of an application described in the header section D1, information indicative of the format for executing the application software programs, and the like (ST2). Since the driver communication control I/F unit 211 is created to correspond to all the interfaces 201 to 205, the CPU 11 can absorb the characteristics of data formats of the interfaces 201 to 205 and thus analyzes the header section D1 even though it receives job data D from any one of the interfaces 201 to 205. In other words, the file formats of data items of different formats such as data size, which are transmitted from the interfaces 201 to 205, can be unified; therefore, the driver communication control I/F unit 211 can correspond to the interfaces 201 to 205.

Based on the above analytical results, the CPU 11 determines whether the job is one for outputting service information (ST3). If the contents of the job represent “output of maintenance information,” the designated maintenance information needs to be output through the interface that has received job data. If the contents of the job represent “updating of firmware,” the status of the updating and the completion thereof need to be output through the interface that has received job data. If, therefore, the contents of the job represent “output of maintenance information” or “updating of firmware,” the CPU 11 determines that the job is one for outputting service information. The processes from step ST1 to step ST3 is performed by the above driver communication control I/F unit 211.

If NO in step ST3, the CPU 11 determines a type of the job data (ST4). Specifically, if the job data is a print job, the CPU 11 determines whether one or both of a data folder for printing and a data folder exclusively for applications are required in order to execute the print job designated by the job data.

If both of the data folders are required to execute a job application, the CPU 11 creates a data folder in a directory exclusively for both printing and applications in the HDD 19 (ST5). If the data folder for printing is required to execute job data, the CPU 11 creates a data folder in a directory for printing in the HDD 19 (ST6). If the data folder exclusively for applications is required to execute job data, the CPU 11 creates a data folder in a director exclusively for applications in the HDD 19 (ST7).

Then, the CPU 11 writes and stores data portion of job data in the data folder created in the HDD 19 (ST8).

When the CPU 11 determines in step ST3 that the job is one for outputting service information and spools data in step ST8, it sets the analytic results of the header section D1 obtained in step ST2 in the unique table provided in the application job control unit 22 in accordance with the job (ST9).

After that, the CPU 11 requests the application job control unit 22 to enter and execute the job (ST10). The CPU 11 determines whether the job to be executed outputs service information (ST11). If No in step ST11, the CPU 11 notifies the application job control unit 22 of a spool data path indicating a directory of the HDD 19, in which data is stored (step ST12). If YES in step ST11, the process of step ST12 is omitted. The processes from step ST4 to step ST12 correspond to those of the above job entry unit 212 and service I/F unit 213. The process to be performed by the CPU 11 upon receiving job data is completed.

Thus, the minimum amount of information, such as information indicating the type of an application such as a print job, information indicating the format of processing, and data storage location information indicating a path to the directory stored in the HDD 19, is supplied to the application job control unit 22 in order to execute one job.

When a job is one for outputting service information, the CPU 11 supplies maintenance information, which is acquired by the results of execution of the job, to an external device through the interface that has received job data.

When the job entered in the table of the application job control unit 22 is, for example, “printing job,” the MFP1 controls the print unit 16 and the like to perform a printing operation. When the job entered in the table of the application job control unit 22 is, for example “output of maintenance information,” the CPU 11 acquires the maintenance information from, e.g., the NVRAM 14 through the service I/F unit 213 and outputs the acquired maintenance information from the interface that has received job data.

The driver communication control I/F unit 211 is common to the respective interfaces 201 to 205. Therefore, even though a new interface is added to the addition/expansion interface (I/F) 206, it is unnecessary to add a module that performs the same process as that of the module provided in the unit 211 for communication control. Since a module necessary only for a newly added interface has only to be added to the driver communication control I/F unit 211, the interface can be added with a minimum of effort.

Since, moreover, the driver communication control I/F unit 211 is created based on the communication control programs corresponding to the most complicated network interface unit, the number of modules to be added can be reduced when an interface is added.

In the embodiment described above, the MFP1 has no facsimile function. However, the present invention can be applied to an image forming apparatus including an MFP1 having a facsimile function and an image forming apparatus to which another function is added.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image forming apparatus comprising:
various interfaces which receive job data;
a communication control module which creates job data of a given file format based on the job data of different formats received by the interfaces;
an entry unit which enters a job in a table based on the job data of the given file format created by the communication control module; and
an application job control unit which executes the job entered in the table of the entry unit.

2. The image forming apparatus according to claim 1, wherein the communication control module is based on a module corresponding to a most complicated one of the interfaces for communication control.

3. The image forming apparatus according to claim 1, wherein the entry unit includes a job entry section which enters a job in a table of the application job control unit and a service interface section which enters a job in the table of the application job control unit, receives data from the application control unit, and supplies the data outside.

4. The image forming apparatus according to claim 3, further comprising a determination unit which determines whether the job is entered in the job entry section or the service interface section based on the job data of the given file format created by the communication control module.

5. The image forming apparatus according to claim 3, further comprising a storage unit which stores image data contained in the job data in an area corresponding to the job.

6. The image forming apparatus according to claim 5, wherein the job entry unit notifies the application job control unit of information indicating the area that stores the image data.

7. A method of controlling communication with an external device of an image forming apparatus, comprising;
receiving job data:
creating job data of a given file format irrespective of a format of the received job data;
entering a job based on the job data of the given file format; and
executing the entered job.

8. The method according to claim 7, further comprising determining whether the created job data of the given file format outputs service information.

9. The method according to claim 8, further comprising discriminating a type of the job data when the job data does not output service information.

10. The method according to claim 9, further comprising storing image data contained in the job data in an area corresponding to the type of the job data.

11. The method according to claim 10, further comprising making a notification about information indicating the area that stores the image data.

12. A module of an image forming apparatus used for communication with an external device, comprising:
a communication control unit which creates job data of a give file format based on job data of different formats received by various interfaces, irrespective of the formats of the receives job data.

13. The module according to claim 12, further comprising an entry unit which enters a job based on the job data of the given file format created by the communication control unit.

14. The module according to claim 13, wherein the entry unit includes a job entry section which enters a job in the application job control unit and a service interface section which enters a job in the application job control unit, receives data from the application control unit, and supplies the data outside.
